(19) United States
(12) Patent Application Publication
(10) Pub. No.: US 2020/0408236 A1
(43) Pub. Date: Dec. 31, 2020

(54) ASSEMBLY PLUG

(71) Applicant: ILLINOIS TOOL WORKS INC., Glenview, IL (US)

(72) Inventor: Sven SÁNCHEZ BURGER, Ingolstadt (DE)

(21) Appl. No.: 16/907,526

(22) Filed: Jun. 22, 2020

(30) Foreign Application Priority Data
Jun. 28, 2019 (DE) 10 2019 117 589.5

(51) Int. Cl. F16B 19/00; F16B 19/10

(52) U.S. Cl. CPC F16B 19/008; F16B 19/1027

(57) ABSTRACT

An assembly plug for closing openings, in particular openings in vehicle bodies and the like, wherein the assembly plug has a first device, which has structure for engaging in a latching manner behind an edge of an opening and there is also a second device, with which the structure for engaging in a latching manner behind an edge of a hole can be actuated radially outward into a latching position, wherein the second device is axially displaceable in the first device and the actuation can be carried out by the axial displacement.

### TECHNICAL FIELD

The invention concerns an assembly plug for closing openings, in particular openings in vehicle bodies.

### BACKGROUND

In many sectors in which assemblies or functional groups containing hollow spaces are formed in particular from metal sheets, said hollow spaces are outwardly provided with openings, with said openings frequently being of oval or round form, for example.

Particularly in vehicle construction, specifically in motor vehicle construction, many vehicle body hollow regions have holes. On the one hand, said holes may therefore mean that the metal sheets have to be positioned during forming or have to be positioned during assembly, with positioning pins engaging in the holes.

Moreover, holes are frequently also provided to allow ingress of liquid into the hollow spaces, for example during phosphating of a vehicle body, and to allow air to escape when the vehicle body is immersed in a phosphating bath or in a cathodic dip coating bath.

After said treatments, or else after hollow space sealing treatments have been performed, hollow spaces of this kind are closed off.

To close off openings of this kind, it is known practice to use rubber plugs which have a plate-like main body from which a plug shank projects, wherein the plug shank typically corresponds approximately to the diameter of the bore or of the hole and, at its free end, has a peripheral shank flange which tapers conically toward the free end, which springs outward elastically after being plugged into and reaching through the hole and which engages with an edge, which typically runs perpendicular to the shank longitudinal axis, behind the bore such that the plug is no longer able to fall out of said hole.

With plugs of this kind, a disadvantage is that, since the peripheral flange is wider than the opening of the hole, they put up considerable resistance to the plugging-in operation and the shank is often bent in the process. In this way, the situation can arise where even though the technician has the impression that the plug is sitting correctly in the vehicle body bore or the hole, the flange does not in fact engage completely behind the hole. Subsequently, on account of the unavoidable vibrations in vehicles, the plug comes out of the hole again and thus the assembly was not successful.

Conscious of such a possible assembly error, an excessive amount of pressure is sometimes exerted on rubber plugs of this kind, such that the plate-like main body moves into the hole and then either has to be manipulated back out or the entire plug falls in, which also prolongs the assembly.

### SUMMARY

The object of the invention is to provide an assembly plug, which can be assembled in a reliable and easy manner and avoids the disadvantages of the prior art.

The object is achieved by an assembly plug having the features of claim 1.

Advantageous developments are identified in the dependent claims.

The assembly plug according to the invention is formed, in at least two parts, of two synthetic material parts, wherein one synthetic material part comprises a radial collar composed of individual spreading hook elements, which have outwardly protruding hook portions, and is connected as preassembled to a second spreading part, wherein in the assembly position the radial collar has an outside diameter which corresponds to that of the hole to be closed or is somewhat smaller and wherein the spreading element is formed such that, in interaction with the radial collar during the plugging-in of the assembly plug and after a stop of the radial collar has been reached, the spreading part is pushed further in and thereby spreads the radial collar outward, such that the flange-like elements engage behind the edge of the hole.

The disadvantages of the prior art are avoided by said refinement according to the invention, and the assembly is also particularly simple and reliable.

In an advantageous development, said assembly plug also has a sealing ring, which is preferably connected in one piece to the radial collar and which, after the radial collar has been pushed in completely by means of the spreading part, bears against the metal sheet surrounding the hole or the like, and said sealing ring firstly providing a sealing function when the radial collar has been spread out by the spreading part and additionally also exerting an elastic restoring force on the assembly plug in such a way that, for example, rattling is avoided and tolerances in the hole depth or the metal sheet thickness are reliably compensated.

The spreading part and the radial collar are in this case pre-engaged in an assembly position, such that said two parts are retained captively against one another. Preferably, the final position, in which the radial collar elements have been spread outward by the spreading part and engage behind the edge of the hole, is likewise provided with an engaging portion in such a way that said position also cannot be spontaneously released. If it is also undesirable for such a plug to be removed and if it is important for the identification of a manipulation of the plug or the hollow space that the manipulation can be coded, then the second engaging position can be non-releasable, such that the plug can be removed only in a destructive manner, wherein at least some of the parts of the plug which are separated as a result of the destruction fall into the hollow space and can remain there as proof of manipulation even if the plug is replaced.

The invention thus concerns, in particular, an assembly plug for closing openings, in particular openings in vehicle bodies and the like, wherein the assembly plug has a first device, which has means for engaging in a latching manner behind an edge of an opening and there is also a second device, with which the means for engaging in a latching manner behind an edge of a hole can be actuated radially outward into a latching position, wherein the second device is axially displaceable in the first device and the actuation can be carried out by the axial displacement.

It can be advantageous when between the first device and the second device there are a pre-engaging position and a final-engaging position, wherein in the pre-engaging position the second device for actuating the latching device is captively pre-mounted and in the second engaging position the second device latches the latching engagement behind the edge of the hole by the first device in an interlocking manner.

In addition, it is advantageous when the first device is a spreading element and the second device is an actuating element, wherein the spreading element has a plurality of spreading hooks, which have in each case an outwardly protruding wall, with which an edge of a hole can be engaged from behind.

In one embodiment, provision is made for the spreading hooks to have obliquely inwardly extending control surfaces, which reduce the diameter of the spreading element, wherein the actuating element is larger than the diameter and is formed in such a way as to displace the spreading hooks radially outward during actuation by way of the control surfaces.

In a further advantageous embodiment, there is a sealing element, wherein the sealing element is arranged on the spreading element, on the outside in the direction of the spreading hooks, and has a device for elastic abutment on a material bounding a hole to be closed or an opening to be closed.

Advantageously, the sealing element can also have a device for elastic abutment between the actuating element and the spreading element.

It is also possible that arranged on the spreading element are radially inwardly protruding latching lugs, which during insertion of the actuating element into the spreading element are formed engaging behind a radial wall of a bead on the actuating element, so that the latching lugs captively retain the actuating element.

It can further be advantageous when the spreading hooks have a radially inwardly protruding step, which is formed interacting with a step of the actuating element, engaging behind in a latching manner.

In particular, the invention also concerns an assembly plug in which the spreading element comprises a base ring, which is formed as a flat disk ring, wherein the spreading hook elements are arranged in a corresponding manner axially on the base ring, axially to one side, wherein the spreading hook elements have the spreading hook shank and the spreading hook head, wherein the spreading hook shank, the spreading hook head and the base ring are formed in one piece.

It is advantageous, in particular, when the spreading hook head outwardly widens the spreading hook shank, which is in each case formed as a cylinder segment, and has a cylindrical planar outer wall with a radially outwardly protruding hook wall, wherein one or two control walls extend from each hook wall to the upper free end of the spreading hook, which is formed on the spreading hook head, wherein the control wall finishes laterally with a side wall of the spreading hook.

According to the invention, it is further advantageous when radially inward on each spreading hook head there protrudes an engaging wall, which, at a distance from the free end, widens the spreading hook head radially inward with a step, wherein from a radially inwardly facing inner edge of the wall there runs along or in the direction of the region of attachment of the spreading hook shank on the base ring a curved control surface, which finishes laterally with the side wall.

In a further advantageous embodiment, the sealing element has a ring-like main body, from which a fin extends obliquely outward along an outer peripheral edge as a device for elastic abutment, wherein under the edge the ring-like main body has a step-like clearance, wherein, on an annular surface lying axially opposite the fin, a peripheral sealing lip running obliquely outward, counter to the direction of extent of the fin, is arranged as a device for elastic abutment.

It is also advantageous when apertures extend from the step through the ring-like main body to a radially inner surface.

Further preferably, the form of the elastic sealing element can be adapted to the spreading element such that the webs reach through the clearances and in the region of the clearances the ring-like main body is formed continuously from the inner wall to the step.

In one embodiment, provision is made for the permanently elastic sealing element and the spreading element to be formed in one piece with one another, but with different material properties.

It can be advantageous, in particular, when the actuating element and the spreading element are formed from a relatively hard synthetic material, such as a plastic or rigid plastic, and the sealing element is formed from a soft, compliant permanently elastic synthetic material.

In addition, it is advantageous when in the preassembled state the actuating element is arranged as pushed axially into the spreading element, wherein the latching lugs reach into the space between the ring and the bead, wherein the outside diameter of the bead and of the ring are dimensioned such that they correspond to the inside diameter of the base ring or are slightly smaller, wherein the actuating element is thereby retained captively on the spreading element by the latching lugs, wherein the latching lugs protrude from the base ring inward from the inner circumferential surface and radially further inward as an inner surface of the spreading hook shank, wherein the latching lugs extend from a lower planar circular surface of the base ring obliquely radially inward and axially in the direction of the spreading hooks.

### BRIEF DESCRIPTION OF THE DRAWINGS

The invention will be explained in exemplary fashion with reference to a drawing, in which:

FIG. 1 shows an embodiment of the assembly plug according to the invention in a preassembled position;

FIG. 2 shows an embodiment of the spreading element of the assembly plug according to the invention;

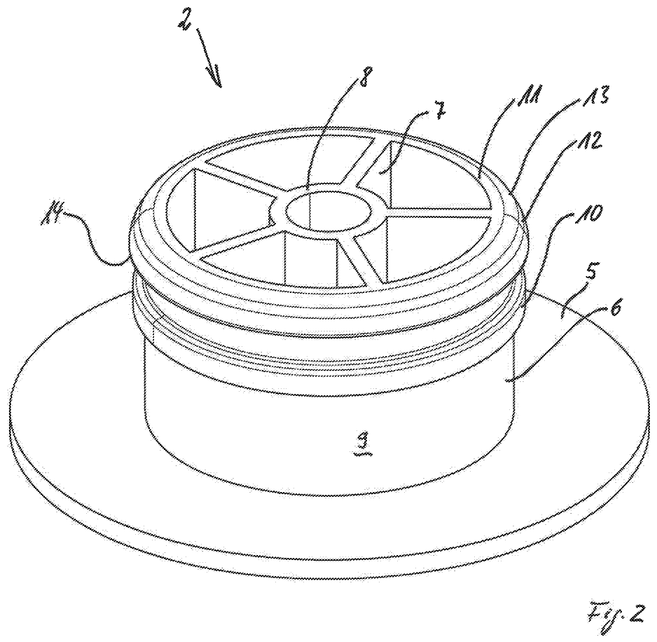

FIG. 3 shows the radial collar element according to the invention;

FIG. 4 shows an embodiment of the sealing element according to the invention;

FIG. 5 shows the radial collar element according to the invention in combination with the sealing element according to the invention;

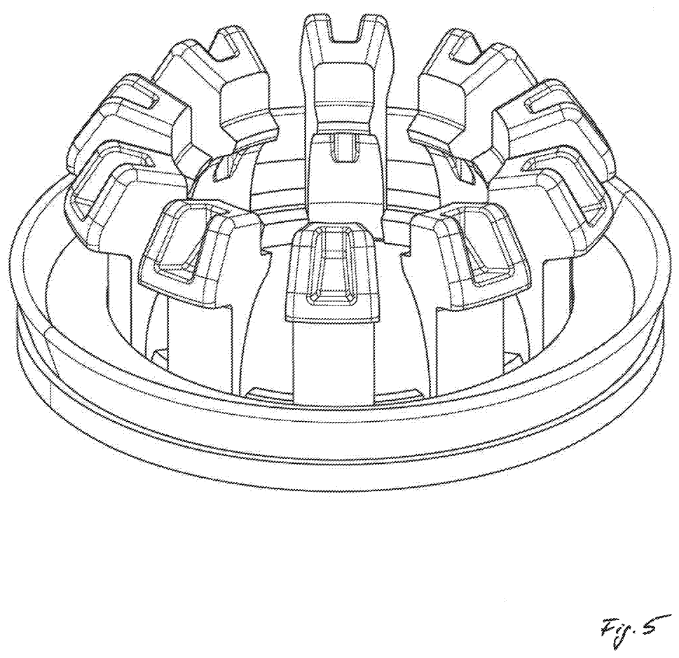

FIG. 6 shows a partially sectioned view of the assembly plug according to the invention prior to being inserted into a vehicle body opening, in the preassembled position;

FIG. 7 shows the assembly plug according to the invention after the radial collar element has been plugged through the vehicle body opening;

FIG. 8 shows the assembly plug according to the invention in the vehicle body opening with the spreading element pushed further in;

FIG. 9 shows the assembly plug according to the invention in a finally assembled position in cross section;

FIG. 10 shows the assembled assembly plug in the assembled position in a view from the radial collar side.

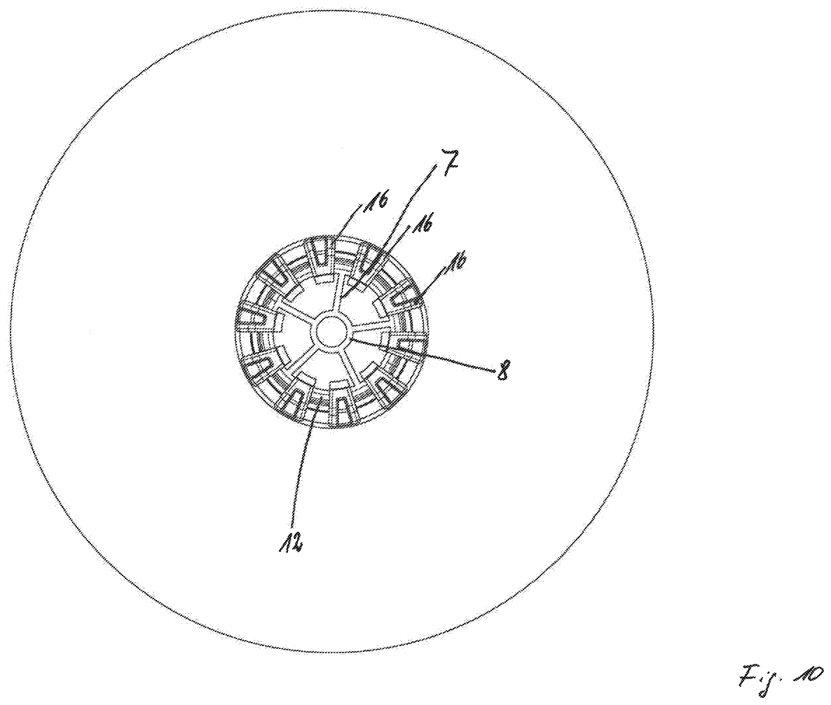

### DETAILED DESCRIPTION

An assembly plug 1 according to the invention has an actuating element 2, a spreading element 3 and possibly a sealing element 4.

The actuating element is an actuating device, with which the spreading element can be actuated as a spreading and latching device.

The sealing element is an element which serves as a sealing device and pre-loading device, wherein the sealing element 4 is an optional component.

The actuating element has a flatly circular disk-shaped main body 5, from which a shank 6 protrudes axially in a coaxial manner, wherein the shank 6 has a diameter which is smaller than the diameter of the main body 5. The shank 6 is of cylindrical form, wherein for manufacturing and/or stability reasons the shank 6 can have reinforcing ribs 7 on the inner side of the cylinder, said reinforcing ribs extending by a central, concentric, coaxial, cylindrical portion 8 with a relatively small diameter to the shank inner side of the shank 6.

The shank 6, on its circumferential wall 9, has a ring 10 at an axial distance from the main body 5.

The ring 10 is at a distance from a free cylinder jacket edge 11, which lies diametrically axially opposite the main body 5.

A latching bead 12 which slopes outward in a roof-like manner extends from the free edge 11 toward the ring 10 or toward the main body 5, wherein the latching bead 12 has the outwardly sloping roof-like surface 13 and a radial wall 14 which runs orthogonally with respect to the jacket wall 9.

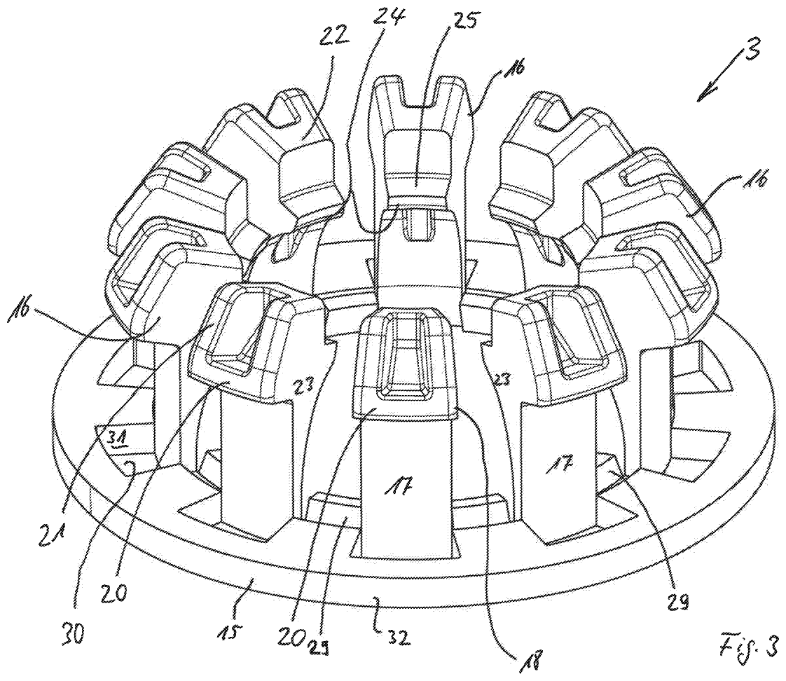

The spreading element 3 (FIG. 3) has a base ring 15, which is formed as a flat disk ring, wherein axially extending spreading hook elements 16 are arranged on the base ring 15, axially to one side. In this case, the spreading hook elements 16 have a spreading hook shank 17 and a spreading hook head 18. Spreading hook shank 17, spreading hook head 18 and base ring 15 are preferably formed in one piece.

The spreading hook head 18 outwardly widens the spreading hook shank 17, which is in each case formed as a cylinder segment, and has a cylindrical planar outer wall 19 with a radially outwardly protruding hook wall 20.

One or two control walls 21 extend from each hook wall 20 to an upper free end 22 of the spreading hook 16, which is formed on the spreading hook head 18. The control walls 21 can finish laterally with a side wall 23 of the spreading hook.

Radially inward on each spreading hook head 18 there protrudes inward an engaging wall 24, which, at a distance from the free end, widens the spreading hook head 18 radially inward with a step 25. From a radially inwardly facing inner edge 26 of the wall 24 there runs along or in the direction of the region of attachment of the spreading hook shank 17 on the base ring 15 a curved control surface 27, which can finish laterally with the side wall 23 and for manufacturing reasons can have a centrally concentric aperture 28.

With regard to the axial extent of the spreading element 3 from the base ring 15 to the free end 22 of the respective spreading hooks 16, the step 25 or the radial wall 24 and the hook wall 20, which faces outward, are arranged with a slight axial offset with respect to one another, wherein the radial wall 24 is somewhat closer to the free end 22, such that the step 25 or the inner edge 26 is formed axially somewhat closer to the free end 22 than the wall 20.

Latching lugs 29 protrude from the base ring 15 inward from the inner circumferential surface and radially further inward as an inner surface of the spreading hook shank 17, said latching lugs extending from a lower planar circular surface of the base ring 15 obliquely radially inward and axially in the direction of the spreading hooks 16.

Between the spreading hooks 16 and the base ring 15 there is arranged, in each case radially in front of a spreading hook 16, a radially outwardly running clearance 30 which tapers toward the base ring 15 but does not cut through. As a result of the clearances 30, webs 31 are formed between the spreading hooks 16, said webs extending from an outer end edge 32 to the latching lugs 29.

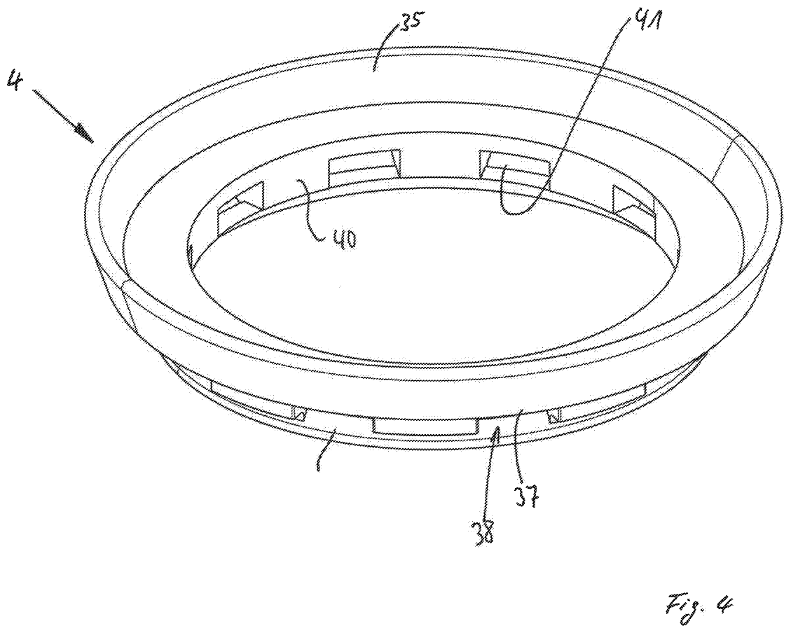

The sealing element 4 (FIG. 4) has a ring-like main body, from which a fin 35 extends obliquely outward along an outer peripheral edge 37. Under the edge 37 the ring-like main body 34 has a step-like clearance 38. On an annular surface 39 lying axially opposite the fin 35, a peripheral sealing lip 36 running obliquely outward, counter to the direction of extent of the fin 35, is arranged.

Apertures 41 extend from the step 38 through the ring-like main body 34 to a radially inner surface 40.

The actuating element 2 and the spreading element 3 are preferably formed from a relatively hard synthetic material, such as a plastic or rigid plastic, whereas the sealing element 4 is preferably formed from a soft, compliant permanently elastic synthetic material.

In this case, the form of the elastic sealing element 4 is adapted to the spreading element 3 such that the webs 31 reach through the clearances 41 and in the region of the clearances 30 the ring-like main body 34 is formed continuously from the inner wall 40 to the step 38.

In accordance with the possibilities of modern manufacturing methods, it is in particular preferable for the permanently elastic sealing element 4 and the spreading element 3 to be formed in one piece with one another, but to have different material properties.

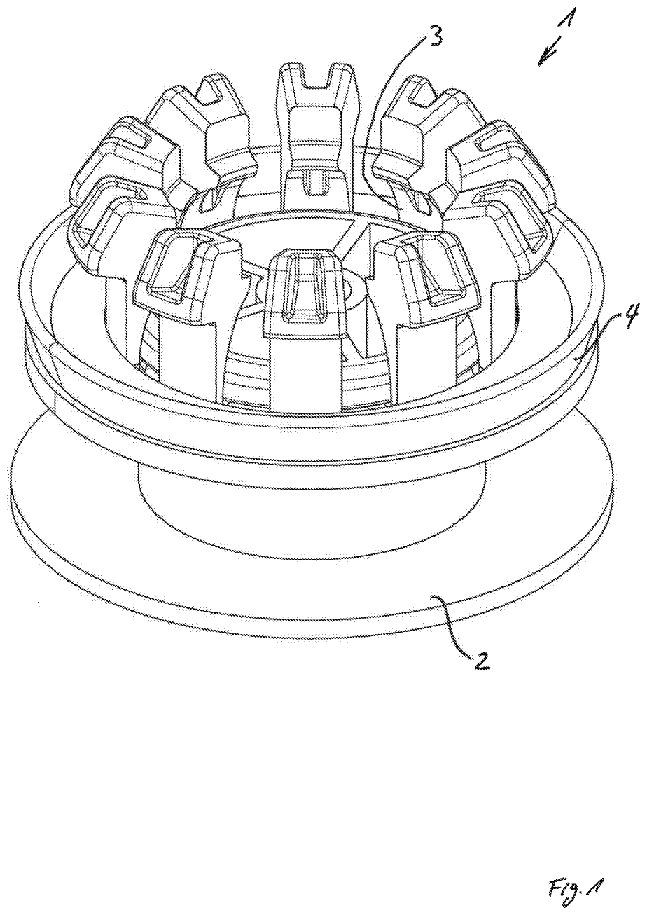

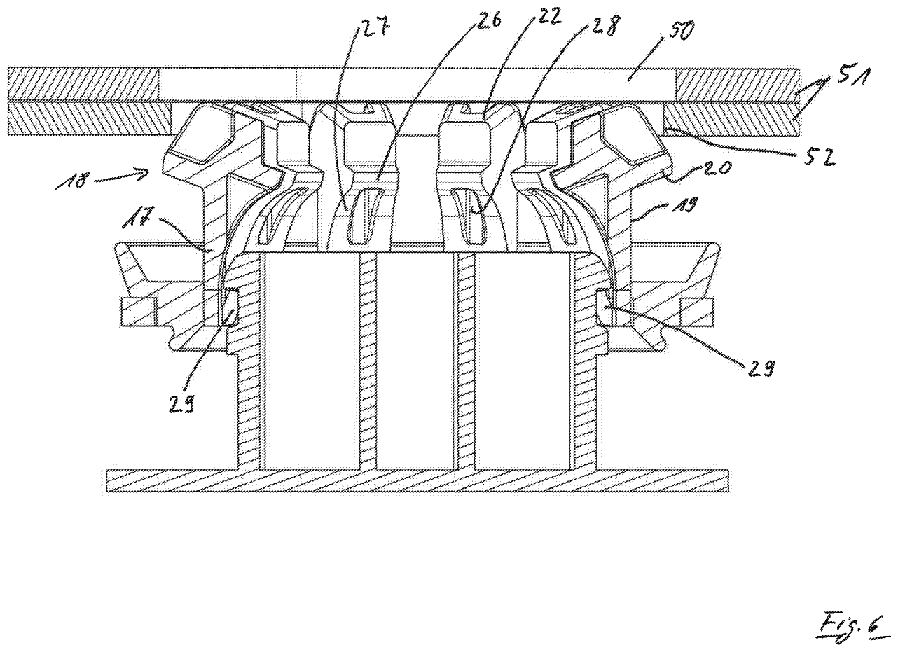

In the preassembled state (FIGS. 1, 6), the actuating element 2 is arranged as pushed axially into the spreading element 3, wherein the latching lugs 29 reach into the space between the ring 10 and the bead 12, wherein the outside diameter of the bead 12 and of the ring 10 are dimensioned such that they correspond to the inside diameter of the base ring 15 or are slightly smaller.

In said preassembly position, the actuating element 2 is retained captively on the spreading element 3 by the latching lugs 29.

To assemble the plug in an opening 50, which is bounded for example by two metal sheets 51, the assembly plug is positioned with the spreading hook heads 18. Preferably, the outside diameter of the spreading hooks 16, that is to say the maximum outer protrusion of the walls 20, is dimensioned such that it is slightly larger than the diameter of the opening 50. The control surfaces 21 of the spreading hook heads 18 thereby bear, between the free ends 22 thereof and an outer edge of the walls 20, against a hole edge 52.

If pressure is then exerted on the main body 5 of the actuating element 2, the ring 10 initially presses against the latching lugs 29 and thus pushes the spreading element 3 somewhat further into the opening 50, wherein the control surfaces 21 slide along the hole edge 52 and thereby ensure that the spreading hooks 16 are bent inward.

As a result of the fact that the spreading hooks are bent inward, the control surfaces 27 which project inward bear against the outer surface 13 of the bead 12, said outer surface sloping in a roof-like manner, and prevent the bead 12 from being able to slide axially thereon.

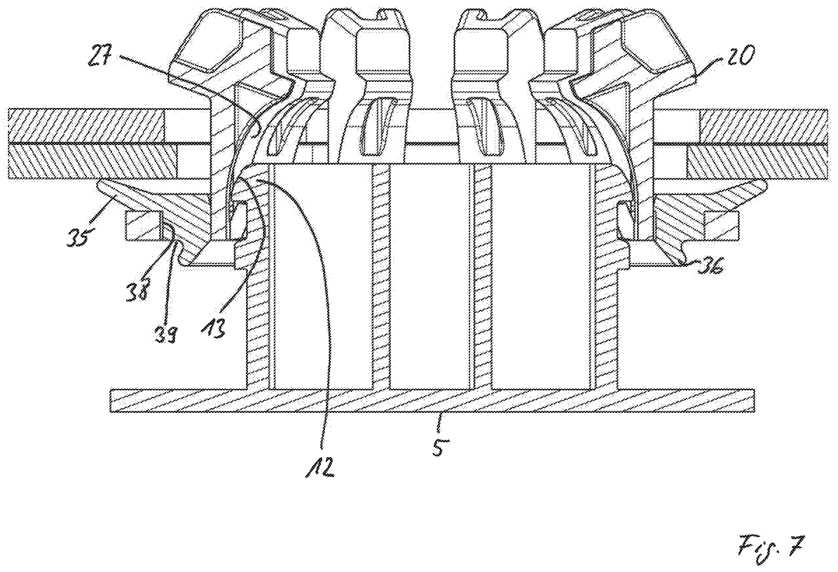

If the wall 20 moves through the opening 50 as a result of said pushing movement (FIG. 7), the spreading hooks spring outward slightly in an elastic manner.

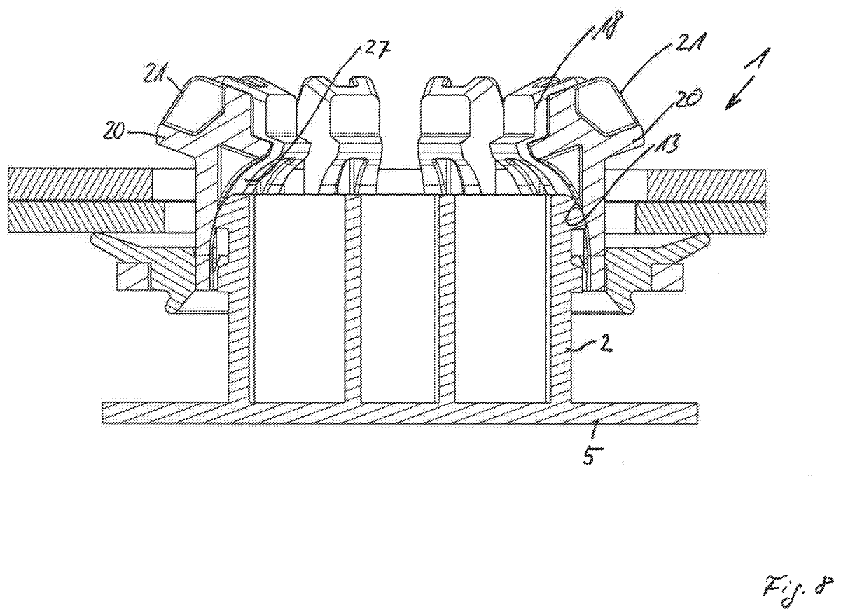

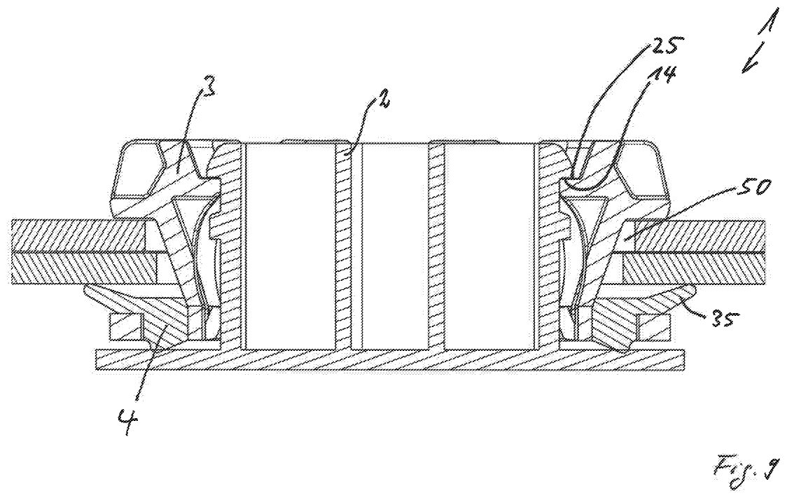

Since the movement outward is then no longer blocked by the surfaces 21, it is possible, with increased pressure on the main body 5 of the actuating element 2, for the surface 13 of the bead 12, said surface sloping in a roof-like manner, to slide along the surfaces 27. Since the shank 6 of the actuating element in particular also cannot be compressed by the reinforcing ribs 7, during the further pushing-in operation, each spreading hook moves outward (FIG. 8, FIG. 9) until the spreading hooks engage behind the material bounding the opening (FIG. 9).

In this case, the bead 12 also runs over the inwardly facing edge 26 or the step 25, such that the radial wall 14 of the bead 12 engages behind the step 25 and the hook elements spring back slightly in an elastic manner, such that the step 25 and the wall 14 interact in a latching manner.

When a sealing element 4 is present, in particular in one piece on the spreading element 3, the fin 35 in this case bears in an elastically deformed manner against the material bounding the hole or the opening 50, whereas the lip 36 bears against the main body 5 of the actuating element, as a result of which, if desired, a sealing action is brought about between the main body 5 and the spreading element 3 on the one hand, in particular the material surrounding the opening 50.

The fin 35 is also supported on the base ring 15 and acts with an elastic restoring force between the base ring 15 and the material surrounding the opening 50, such that a play, which would lead to rattling, is prevented between the spreading element and the material surrounding the opening, which is closed.

In addition, the lip 36 also prevents a play between the actuating element 2 and the spreading element 3.

In the invention, a spreading element is thus introduced with engaging elements into an opening such that the engaging elements engage behind the edge of the opening by means of the actuating element and the actuating element, in turn, interlocks in the spreading element, such that the interlocking of the actuating element in the spreading element interlocks the spreading action and the spreading element is interlocked, and anchored, between the spreading element and the material surrounding an opening. In this way, the opening to be closed is closed off by the main body of the actuating element, possibly assisted by a sealing element.

In the invention, it is advantageous for holes and in particular holes in vehicle bodies and the like to be able to be reliably closed, and when a sealing element is present to also be able to be sealed off, by the assembly plug according to the invention in a simple, reliable and comprehensible manner which is not susceptible to error.

A person skilled in the art understands that the sealing element, which in the present case is formed in one part and is otherwise formed in one piece with the spreading element, can also be a separate part, which is for example retained merely in a clamping manner between the actuating element and the spreading element or is adhesively bonded to one of the two elements or is fastened thereon with a groove, or the like.

The number of spreading hooks is arbitrary and is selected in a manner dependent on the material such that the spreading hooks are not too delicate, in order, on the one hand, to maintain the elastic restoring forces and, on the other hand, to avoid breakage during the assembly. There are also not only so few spreading hooks that the elastic restoring forces during the assembly are too great. By way of example, use is made of between 6 and 14 spreading hooks, wherein the number of spreading hooks is also dependent on the diameter of the hole.

It goes without saying that, with corresponding shaping, not only round holes but also oval vehicle body openings and other vehicle body openings of any desired shaping can be closed with such an assembly plug.

### LIST OF REFERENCE SIGNS

1. Assembly plug
2. Actuating element
3. Spreading element
4. Sealing element
5. Main body
6. Shank
7. Reinforcing ribs
8. Central cylinder
9. Jacket wall
10. Ring
11. Free edge
12. Bead
13. Roof-like surface
14. Radial wall
15. Base ring
16. Spreading hook
17. Spreading hook shank
18. Spreading hook head
19. Outer wall of 17
20. Hook wall
21. Control wall
22. Free end
23. Side wall
24. Radial wall
25. Step
26. Radially inner wall
27. Control surface
28. Aperture
29. Latching lug
30. Clearance
31. Webs
32. End edge
34. Ring-like main body
35. Fin
36. Sealing lip
37. Outer edge
38. Step-like clearance
39. Annular surface
40. Radially inner surface
41. Aperture

What is claimed is:

1. An assembly plug for closing openings, comprising:
a first device (3), which has means (16) for engaging in a latching manner behind an edge of an opening and there is also a second device (2), with which the means (16) for engaging in a latching manner behind an edge of a hole can be actuated radially outward into a latching position, wherein the second device (2) is axially displaceable in the first device (3) and the actuation can be carried out by the axial displacement.

2. The assembly plug as claimed in claim 1,
wherein, between the first device (2) and the second device (3), there are a pre-engaging position and a final-engaging position, wherein in the pre-engaging position the second device for actuating the first latching device is captively pre-mounted and in the second engaging position the second device latches the latching engagement behind the edge of the hole by the first device in an interlocking manner.

3. The assembly plug as claimed in claim 1,
wherein the first device is a spreading element and the second device is an actuating element (2), wherein the spreading element (3) has a plurality of spreading hooks (16), which have in each case an outwardly protruding wall (25), with which an edge of a hole can be engaged from behind.

4. The assembly plug as claimed claim 3,
wherein the spreading hooks have obliquely inwardly extending control surfaces (27), which reduce the diameter of the spreading element (3), wherein the actuating element (2) is larger than the diameter and is formed in such a way as to displace the spreading hooks (16) radially outward during actuation by way of the control surfaces (27).

5. The assembly plug as claimed in claim 3,
wherein a sealing element (4) is arranged on the spreading element (3), on the outside in the direction of the spreading hooks (16), and has a device (35) for elastic abutment on a material bounding a hole to be closed or an opening to be closed.

6. The assembly plug as claimed in claim 5,
wherein the sealing element also has a device (36) for elastic abutment between the actuating element (2) and the spreading element (3).

7. The assembly plug as claimed in claim 3,
wherein, on the spreading element (3), are radially inwardly protruding latching lugs (29), which during insertion of the actuating element (2) into the spreading element (3) are formed engaging behind a radial wall (14) of a bead (12) on the actuating element (2), so that the latching lugs (29) captively retain the actuating element (2).

8. The assembly plug as claimed in claim 3,
wherein the spreading hooks (16) have a radially inwardly protruding step, which is formed interacting with a step (14) of the actuating element (2), engaging behind in a latching manner.

9. The assembly plug as claimed in claim 3,
wherein the spreading element (3) comprises a base ring (15), which is formed as a flat disk ring,
wherein the spreading hook elements are arranged in a corresponding manner axially on the base ring (15), axially to one side,
wherein the spreading hook elements (16) have a spreading hook shank (17) and a spreading hook head (18),
wherein the spreading hook shank (17), the spreading hook head (18) and the base ring (15) are formed in one piece.

10. The assembly plug as claimed in claim 9,
wherein the spreading hook head (8) outwardly widens the spreading hook shank (17), which is in each case formed as a cylinder segment, and has a cylindrical planar outer wall with a radially outwardly protruding hook wall (20),
wherein one or two control walls (21) extend from each hook wall (20) to the upper free end (22) of the spreading hook (16), which is formed on the spreading hook head (18), wherein the control wall (21) finishes laterally with a side wall (23) of the spreading hook.

11. The assembly plug as claimed in claim 10,
characterized
in that radially inward on each spreading hook head (18) there protrudes inward an engaging wall (24), which, at a distance from the free end, widens the spreading hook head (18) radially inward with a step (25),
wherein from a radially inwardly facing inner edge (26) of the wall (24) there runs along or in the direction of the region of attachment of the spreading hook shank (17) on the base ring (15) a curved control surface (27), which finishes laterally with the side wall (23).

12. The assembly plug as claimed in claim 5,
wherein the sealing element (4) has a ring-like main body,
from which a fin (35) extends obliquely outward along an outer peripheral edge (37) as a device (35) for elastic abutment,
wherein under the edge (37) the ring-like main body (34) has a step-like clearance (38),
wherein, on an annular surface (39) lying axially opposite the fin (35), a peripheral sealing lip (36) running obliquely outward, counter to the direction of extent of the fin (35), is arranged as a device (36) for elastic abutment.

13. The assembly plug as claimed in claim 12,
wherein apertures (41) extend from the step (38) through the ring-like main body (34) to a radially inner surface (40),
wherein the form of the elastic sealing element (4) is adapted to the spreading element (3) such that the webs (31) reach through the clearances (41) and in the region of the clearances (30) the ring-like main body (34) is formed continuously from the inner wall (40) to the step (38).

14. The assembly plug as claimed in claim 5,
wherein the permanently elastic sealing element (4) and the spreading element (3) are formed in one piece with one another, but with different material properties,
wherein the actuating element (2) and the spreading element (3) are formed from a relatively hard synthetic material,
and the sealing element (4) is formed from compliant permanently elastic synthetic material.

15. The assembly plug as claimed in claim 7,
characterized
in that in the preassembled state the actuating element (2) is arranged as pushed axially into the spreading element (3),
wherein the latching lugs (29) reach into the space between a ring (10) and the bead (12),
wherein the outside diameter of the bead (12) and of the ring (10) are dimensioned such that they correspond to the inside diameter of the base ring (15) or are slightly smaller,
wherein the actuating element (2) is thereby retained captively on the spreading element (3) by the latching lugs (29),
wherein the latching lugs (29) protrude from the base ring (15) inward from the inner circumferential surface and radially further inward as an inner surface of the spreading hook shank,
wherein the latching lugs (29) extend from a lower planar circular surface of the base ring (15) obliquely radially inward and axially in the direction of the spreading hooks (16).
